(19) United States
(12) Patent Application Publication
(10) Pub. No.: US 2024/0323956 A1
(43) Pub. Date: Sep. 26, 2024

(54) CONTROL INFORMATION MULTIPLEXING FOR WIRELESS COMMUNICATIONS

(71) Applicant: ZTE Corporation, Shenzhen (CN)

(72) Inventors: Shuaihua KOU, Shenzhen (CN); Wei GOU, Shenzhen (CN); Xianghui HAN, Shenzhen (CN); Junfeng ZHANG, Shenzhen (CN)

(73) Assignee: ZTE Corporation, Shenzhen, GD (CN)

(21) Appl. No.: 18/680,699

(22) Filed: May 31, 2024

Related U.S. Application Data
(63) Continuation of application No. PCT/CN2022/108691, filed on Jul. 28, 2022.

(51) Int. Cl. H04W 72/1268; H04W 72/232

(52) U.S. Cl. CPC H04W 72/1268; H04W 72/232

(57) ABSTRACT

This document generally relates to wireless communication that includes a user device that determines whether a first value indicated by a first type of downlink control information (DCI) matches a second value indicated by a second type of DCI. The user device selects a candidate physical uplink shared channel (PUSCH) for uplink control information (UCI) multiplexing based on at least determining whether the first and second values match. Also, a wireless access node transmits the first type of DCI and the second type of DCI, and receives a PUSCH with a multiplexed UCI corresponding to at least whether the first and second values match.

### CROSS-REFERENCE TO RELATED APPLICATION(S)

This application is a continuation of International Patent Application No. PCT/CN2022/108691, filed Jul. 28, 2022. The contents of International Patent Application No. PCT/CN2022/108691 are herein incorporated by reference in their entirety.

### TECHNICAL FIELD

This document is directed generally to control information multiplexing for wireless communication.

### BACKGROUND

In wireless communication systems, in event that a physical uplink control channel (PUCCH) for carrying an uplink control information (UCI) (e.g., a hybrid automatic repeat request (HARQ) information) overlaps with a physical uplink shared channel (PUSCH), the UCI may be multiplexed in the PUSCH. The HARQ information may include one or more codebooks indicated by a downlink control information (DCI). However, if a user device 102 misses the DCI, especially a last DCI, the user device 102 may not be aware of a corresponding PUCCH resource, or may determine a wrong PUCCH resource. This may cause the user device 102 not perform UCI multiplexing or perform UCI multiplexing incorrectly, and/or may cause the network to not decode the UCI or the PUSCH. Ways to enable correct UCI multiplexing and correct decoding of UCIs and PUSCHs may be desirable.

### SUMMARY

This document relates to methods, systems, apparatuses and devices for wireless communication. In some implementations, a method for wireless communication includes: determining, by a user device, whether a first value indicated by a first type of downlink control information (DCI) matches a second value indicated by a second type of DCI; and selecting, by the user device, a candidate physical uplink shared channel (PUSCH) for uplink control information (UCI) multiplexing based on at least determining whether the first value matches the second value.

In some other implementations, a method for wireless communication includes: transmitting, by a wireless access node, a first type of downlink control information (DCI) indicating a first value and a second type of DCI indicating a second value; and receiving, by the wireless access node, a physical uplink shared channel (PUSCH) with a multiplexed uplink control information (UCI) corresponding to at least whether the first value and the second value match.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows an example method for wireless communication that relates to selecting candidate PUSCHs for UCI multiplexing.

FIG. 3 shows an example method for wireless communication that relates to receiving a PUSCH corresponding to whether values in first and second types of DCIs match.

FIG. 4 shows a diagram of an example of PUSCH and PUCCH resources in the time domain.

FIG. 5 shows a diagram of another example of PUSCH and PUCCH resources in the time domain.

### DETAILED DESCRIPTION

The present description describes various embodiments of systems, apparatuses, devices, and methods for wireless communications involving selecting candidate PUSCHs for control information multiplexing.

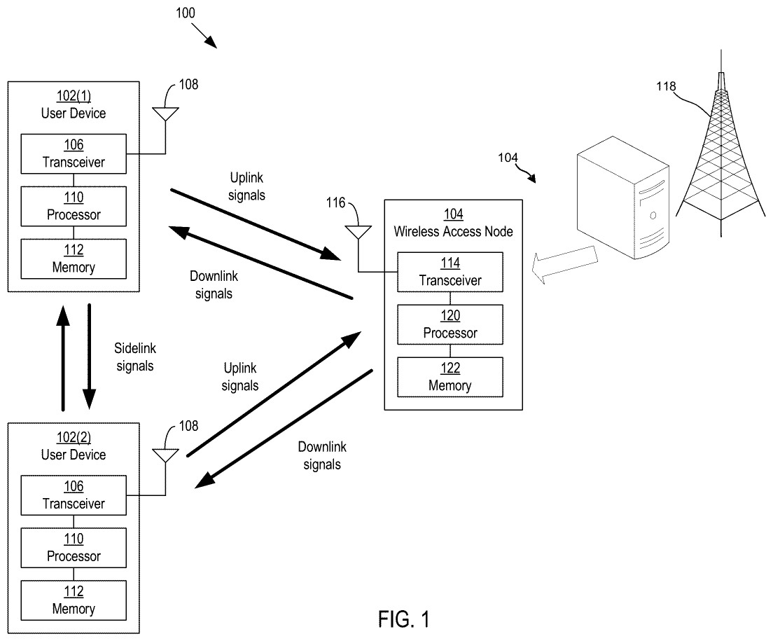

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In addition, referring back to FIG. 1, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

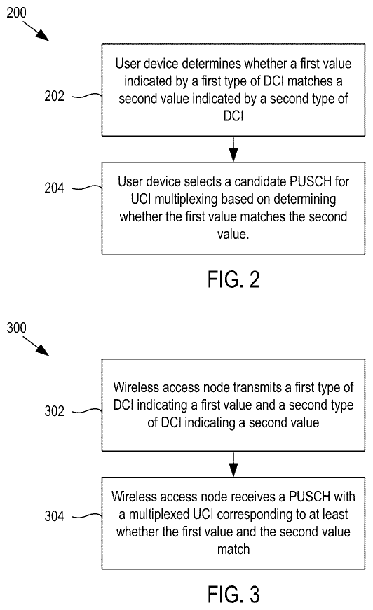

FIG. 2 shows a flow chart of an example method 200 of wireless communication that relates to determining candidate PUSCHs for UCI multiplexing. At block 202, a user device 102 may determine whether a first value indicated by a first type of DCI matches a second value indicated by a second type of DCI. As described in further detail below, for some embodiments, the first and second values may each be downlink assignment index (DAI) values indicated by DAI fields in the first type of DCI and the second DCI, respectively. In other embodiments, the first and second values are values in fields of the first and second type of DCIs, respectively, where the first and second values each indicate whether to trigger a type3 codebook or a retransmitted codebook. Details of various embodiments of the method 200 are described in further detail below.

FIG. 3 shows a flow chart of an example method 300 of wireless communication that relates to receiving a PUSCH corresponding to whether values indicated by first and second types of DCIs match. At block 302, the wireless access node 104 may transmit a first type of DCI indicating a first value and a second type of DCI indicating a second value. At block 304, the wireless access node 104 may receive a PUSCH with a multiplexed UCI corresponding to at least whether the first value and the second value match. In various embodiments, the PUSCH may be a PUSCH that a user device 102 selects as a candidate PUSCH for UCI multiplexing based on whether the first and second values match. For at least some of these embodiments, the PUSCH that the wireless access node 104 receives from the user device 102 may be multiplexed with HARQ information bits.

In further detail, in some embodiments, the wireless access node 104 may transmit a plurality of a first type of DCIs to the user device 102. The plurality of the first type of DCIs may schedule a plurality of PDSCHs transmitted from the wireless access node 104 to the user device 102. In addition, each of the plurality of the first type of DCIs may schedule one or more PDSCHs. Also, each of the plurality of the first type of DCIs may indicate a PUCCH resource. For at least some of these embodiments, two or more of the plurality of the first type of DCIs may indicate the same PUCCH resource. The indicated PUCCH resource may be in the same slot. Also, each of the first type of DCIs may include (or indicate) a downlink assignment index (DAI). The DAI value indicated by a first type of DCI may be ‘1’, ‘2’, ‘3’, or ‘4’, etc. The DAI in the first type of DCI may be a counter DAI or a total DAI. In some embodiments, the first type of the DCI is also referred to as a downlink (DL) DCI in that the DCI schedules a downlink transmission.

Additionally, the wireless access node 104 may transmit a plurality of a second type of DCIs to the user device 102. The plurality of the second type of DCIs may schedule a plurality of PUSCHs. Each of the plurality of the second type of DCIs may schedule one or more PUSCHs. The plurality of the PUSCHs may be in the same slot as the PUCCH resource. The indicated PUCCH resource may overlap with at least one of the plurality of PUSCHs. The second type of DCI may include (or indicate) a downlink assignment index (DAI). The DAI in the second type of DCI may indicate a value ‘1’, ‘2’, ‘3’, or ‘4’, etc. In some embodiments, the second type of the DCI is also referred to as an uplink (UL) DCI in that the DCI schedules an uplink transmission.

From the perspective of the user device 102, the user device 102 may receive, decode, and/or detect at least one of the plurality of second type of DCIs correctly. In addition, the user device 102 may receive, decode, and/or detect at least one of the plurality of first type of DCIs. Also, the user device 102 may be aware of the PUCCH resource indicated by the at least one of the plurality of the first type of DCIs. In a first case, a first DAI value indicated by the at least one of the plurality of the first type of DCIs may match (e.g., be equal to or otherwise satisfy a predetermined relationship or correspondence with) a second DAI value indicated by the second type of DCI. In event that the user device 102 determines that the first and second DAI values match, then, in response, the user device 102 may select those one or more PUSCHs of the plurality of PUSCHs that overlap with the PUCCH resource as candidate PUSCHs for UCI (e.g., HARQ information) multiplexing. In various embodiments, the PUCCH resource may be indicated by the first type of DCI. More specifically, if the first DAI value indicated by a last DCI of the at least one of the plurality of the first type of DCIs matches the second DAI value indicated by the second type of DCI, then, in response, the user device 102 may select the one or more PUSCHs that overlaps with the PUCCH resource as the candidate PUSCHs for UCI (e.g., HARQ information) multiplexing. The PUCCH resource may be indicated by the last DCI of the at least one of the plurality of the first type of DCIs. For at least some embodiments or in some situations, the last DCI of the at least one of the plurality of the first type of DCI may have the largest first DAI value.

In a second case, the user device 102 may determine that the first DAI value indicated by the at least one of the plurality of the first type of DCIs may not match (e.g., not equal to or otherwise not have a predetermined correspondence or relationship with) the second DAI value indicated by the second type of DCI. In response to the first and second DAI values not matching, the user device 102 may select those one or more PUSCHs that are scheduled by the second type of the DCIs that have second DAI values not equal to 4 as the candidate PUSCHs for UCI (e.g., HARQ information) multiplexing. More specifically, if the first DAI value indicated by a last DCI of the at least one of the plurality of the first type of DCIs is not equal to the second DAI value indicated by the second type of DCI, then, in response, the user device 102 may select the PUSCHs that are scheduled by the second type of the DCIs that have a second DAI value not equal to 4 as the candidate PUSCHs for UCI (e.g., HARQ information) multiplexing.

In a third case, the user device 102 may not receive any one of the plurality of the first type of DCIs. Correspondingly, the user device 102 may not be aware of a PUCCH resource. In this third case, the user device 102 may select those one or more PUSCHs that is scheduled by the second type of the DCIs that have a second DAI value not equal to 4 as the candidate PUSCHs for UCI (e.g., HARQ information) multiplexing.

In addition, in some embodiments, the plurality of the second type of DCIs may indicate the same DAI value. For such embodiments, for determining whether the first and second DAI values match, the user device 102 may use the second DAI value indicated by any of the plurality of the second type of DCIs.

In some embodiments, the plurality of the second type of DCIs may indicate the different DAI value. For determining whether the first and second DAI values match, a second DAI value indicated by the second type of DCI may be used if the indicated second DAI value is not equal to 4. For example, the second DAI value indicated by the second type of DCI may be ‘2’, ‘2’, ‘4’, ‘4’, respectively. Then the second DAI value ‘2’ may be used to determine whether the first and second DAI values match.

Also, in some embodiments, for determining whether the first and second DAI values match, the user device 102 may use the second DAI value indicated by a last second type of the DCI that is received by the user device 102.

In addition, in some embodiments for the second case and/or the third case, the user device 102 may select the PUSCHs scheduled by the second type of the DCIs that have the second DAI values that match the second DAI value indicated by the last second type of the DCI that is received by the user device 102 as the candidate PUSCHs for UCI (e.g., HARQ information) multiplexing. For example, suppose the second DAI values indicated by the second type of DCIs are ‘2’, ‘2’, ‘3’, ‘3’, respectively. Correspondingly, the second DAI value indicated by the last DCI is ‘3’. In turn, the user device 102 may use the second DAI value of ‘3’ to determine whether the first DAI value indicated by the first type of the DCIs matches the second DAI values indicated by the second type of the DCIs. Additionally, for the second case and/or the third case, the PUSCH scheduled by the second type of DCIs that have the second DAI value ‘3’ may be selected as the candidate PUSCHs for UCI (e.g., HARQ information) multiplexing. To illustrate, using the above example, the user device 102 may select the PUSCHs scheduled by the third and fourth second type of DCIs since those second type of DCIs indicated second DAI values of ‘3’.

Also, in some embodiments, for determining whether the first DAI value indicated by the first type of DCI matches the second DAI value indicated by the second type of the DCI, the user device 102 may use the largest DAI value indicated by the second type of the DCI that is received by the user device 102. For the second case and/or the third case, the user device 102 may select the PUSCHs scheduled by the second type of the DCIs that have the largest DAI value as the candidate PUSCHs for UCI (e.g., HARQ information) multiplexing. To illustrate as an example, suppose the second DAI values indicated by the second type of DCIs are ‘4’, ‘5’, ‘5’, respectively. Since the second DAI value ‘5’ is the largest, then the user device 102 may use the second DAI value ‘5’ to determine whether the first and second DAI values match. Also, for the second and third cases, the user device 102 may select the PUSCHs scheduled by the second and third second type of DCIs as candidate PUSCHs for UCI (e.g., HARQ information) multiplexing since those second type of DCIs have second DAI values of ‘5’.

Also, in various embodiments, the user device 102 may select a specific PUSCH from the candidate PUSCHs for UCI (e.g., HARQ information) multiplexing. For example, from the candidate PUSCHs, the user device 102 may select the PUSCH in the serving cell with the smallest serving cell index for UCI (e.g., HARQ information) multiplexing. If there are more than one PUSCHs in the serving cell with the smallest serving cell index, the user device 102 may select the earliest PUSCH for UCI (e.g., HARQ information) multiplexing. In addition, the user device 102 may generate the HARQ codebook by using the second DAI value indicated by the second type of the DCI that schedule the specific PUSCH selected by the user device 102. The HARQ information bits of the generated HARQ codebook may be multiplexed in the specific PUSCH. The user device 102 may transmit at least the specific PUSCH with the multiplexed HARQ information bits.

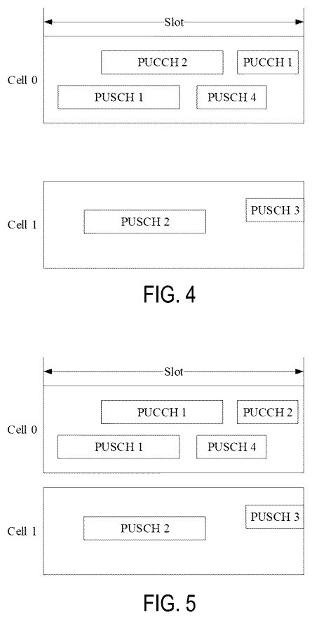

FIG. 4 illustrates an example of the candidate PUSCH determination for UCI multiplexing. The example in FIG. 4 shows two serving cells, denoted by cell 0 and cell 1, respectively. PUCCH 1 overlaps with both PUSCH 3 and PUSCH 4 in the time domain. PUCCH 2 overlaps with PUSCH 1, PUSCH 2 and PUSCH 4 in the time domain.

Further, suppose in the example in FIG. 4 that PUCCH 1 and PUCCH 2 are scheduled by first type of DCIs DCI 1_1 and DCI 1_2, respectively. The first DAI values in the DCI 1_1 and 1_2 are ‘1’, and ‘2’, respectively.

Also, suppose in the example that PUSCH 1, PUSCH 2, PUSCH 3 and PUSCH 4 are scheduled by second type of DCIs DCI 2_1, DCI 2_2, DCI 2_3, and DCI 2_4, respectively. The second DAI values in the DCI 2_1, DCI 2_2, DCI 2_3, and DCI 2_4 are ‘2’, ‘2’, ‘4’, and ‘2’, respectively. The user device 102 receives DCI 2_1, DCI 2_2, DCI 2_3 and DCI 2_4 correctly. Therefore, the user device 102 may use the second DAI value of ‘2’ to determine whether the first DAI value matches the second DAI value.

Further, suppose that in the example in FIG. 4, in a first case, the user device 102 only receives DCI 1_1 correctly. In other words, the user device 102 does not decode DCI 1_2 correctly. Correspondingly, the user device 102 may be aware of only the PUCCH 1. From the perspective of the user device 102, DCI 1_1 is the last DCI of the first type of DCIs. The first DAI value indicated by DCI 1_1 does not match (e.g., by not being equal to) the second DAI value(s) indicated by at least one of DCI 2_1, DCI 2_2, DCI 2_3 and DCI 2_4. Accordingly, the user device 102 selects PUSCH 1, PUSCH 2 and PUSCH 4 as candidate PUSCHS, which are scheduled by the first type of DCIs indicating the first DAI value ‘2’.

In another case, suppose that the user device 102 receives both DCI 1_1 and DCI 1_2. Correspondingly, the user device 102 can be aware of the PUCCH 2. From the perspective of the user device 102, DCI 1_2 is the last DCI of the first type of DCIs. The first DAI value indicated by DCI 1_2 matches (e.g., by being equal to) the second DAI value indicated by DCI 2_1, DCI 2_2, or DCI 2_4. Thus, the user device 102 selects the PUSCHs overlapping with PUCCH 2 as the candidate PUSCHs, i.e., PUSCH 1, PUSCH 2 and PUSCH 4.

In another case, the user device 102 does not decode both DCI 1_1 and 1_2 correctly. Correspondingly, the user device 102 cannot be aware of both PUCCH 1 and PUCCH 2. In addition, the second DAI value indicated by DCI 2_1, DCI 2_2, or DCI 2_3 is not equal to 4. Therefore, the user device 102 selects PUSCH 1, PUSCH 2 and PUSCH 4 as candidate PUSCHs.

In any case, the user device 102 may use the DAI value ‘2’ for HARQ codebook construction. Among these candidate PUSCHs, PUSCH 1 is selected for UCI multiplexing since cell 0 has the smallest cell index, on which PUSCH 1 is earlier than PUSCH 4. Then the HARQ information bits of the HARQ codebook may be multiplexed in PUSCH 1.

With the above embodiments, the user device 102 can determine the correct candidate PUSCH for UCI multiplexing even though it may not decode some DL DCI.

In addition or alternatively, in some embodiments, the wireless access node 104 may configure a plurality of serving cells for a user device 102. The plurality of serving cells may belong to a same PUCCH group (or PUCCH cell group). Also, there may be a plurality of HARQ processes in a serving cell. Also, for at least some of these embodiments, there may be different numbers of HARQ processes for different serving cells.

Additionally, in some embodiments, the user device 102 may construct (or generate) a first HARQ codebook, such as by concatenating the HARQ information bits for the HARQ processes for the plurality of serving cells together. In some embodiments, the first HARQ codebook is also referred to as type3 codebook. More specifically, the user device 102 may concatenate the HARQ information bits in the order of at least one of: a code block group (CBG) index, a transport block (TB) index, a HARQ process index, or a serving cell index. For example, the user device 102 may concatenate the HARQ information bits first in the ascending (or descending) order of the CBG index, second in the ascending (or descending) order of the TB index, third in the ascending (or descending) order of the HARQ process index, fourth in the ascending (or descending) order of the serving cell index.

For example, in various embodiments, the wireless access node 104 may configure a certain number of (e.g., four) serving cells for a user device 102. Each cell may have a certain number of (e.g., sixteen) HARQ processes. The codebook includes the HARQ information for all the certain number of HARQ processes for all the certain number of cells.

In a first case, a new data indicator (NDI) value for a TB for a HARQ process of a serving cell may also be included in the codebook. The NDI value for a TB of a HARQ process of a serving cell may be indicated by a DCI. If the NDI value for a TB of a HARQ process of a serving cell is not indicated by a DCI, the NDI value may be assumed to be ‘0’. For a TB of a SPS PDSCH or of a PDSCH scheduled by a DCI scrambled by CS-RNTI, the NDI value may be assumed to be ‘0’ or ‘1’. If there is no HARQ information for a TB of a HARQ process of a serving cell, the HARQ information bits may be assumed to be ‘0’ for the TB or for all the CBGs of the TB.

In another case, the NDI value may not be included in the codebook. For a TB of a HARQ process of a serving cell or for all the CBGs of a TB of a HARQ process of a serving cell, the HARQ information bits may be set to ‘0’, if at least one of the conditions is satisfied, 1) the user device 102 has reported the HARQ information bits for the TB of the HARQ process of the serving cell or for all the CBGs of the TB of the HARQ process of the serving cell, or 2) the user device 102 has not received a PDSCH corresponding to the HARQ process on the serving cell after the user device 102 has reported the HARQ information bits for the HARQ process on the serving cell.

In some embodiments, the user device 102 may report the HARQ information for a transport block (TB) for a serving cell in a PUCCH or a PUSCH. If the transmission of the PUCCH or the PUCCH is canceled by the user device 102 or cannot be transmitted by the user device 102 finally, the user device 102 may consider or determine that the HARQ information for the TB for the serving cell has not been reported by the user device 102.

In some embodiments, the user device 102 may report the HARQ information for a TB for a serving cell in a plurality of PUCCHs or PUSCHs. That is, the plurality of PUCCHs or PUSCHs may carry the HARQ information for the TB for the serving cell. In one case, if at least one of the plurality of PUCCHs or PUSCHs is canceled by the user device 102 or cannot be transmitted by the user device 102 finally, the user device 102 may consider or determine that the HARQ information for the TB for the serving cell has not been reported by the user device 102. In another case, if the user device 102 transmits at least one of the plurality of PUCCHs or PUSCHs successfully, the user device 102 may consider or determine that the HARQ information for the TB for the serving cell has been reported by the user device 102.

In some embodiments, if the number of the plurality of PUCCHs or PUSCH that is transmitted by the user device 102 successfully is larger than (or larger than or equal to) a threshold number, the user device 102 may consider or determine that the HARQ information for the TB for the serving cell has been reported by the user device 102. If the number of the plurality of PUCCHs or PUSCH that is transmitted by the user device 102 successfully is smaller than (or smaller than or equal to) a threshold number, the user device 102 may consider or determine that the HARQ information for the TB for the serving cell has not been reported by the user device 102. Alternatively, if the number of the plurality of PUCCHs or PUSCH that is canceled by the user device 102 or cannot be transmitted by the user device 102 finally is larger than (or larger than or equal to) a threshold number, the user device 102 may consider or determine that the HARQ information for the TB for the serving cell has not been reported by the user device 102. If the number of the plurality of PUCCHs or PUSCH that is canceled by the user device 102 or cannot be transmitted by the user device 102 finally is smaller than (or smaller than or equal to) a threshold number, the user device 102 may consider or determine that the HARQ information for the TB for the serving cell has been reported by the user device 102. The wireless access node 104 may configure the threshold number for the user device 102. Additionally or alternatively, the threshold number may be specified by the standard or protocol.

In some embodiments, a second type of (e.g., UL) DCI may schedule one or more PUSCHs. There may be a first field in the second type of (e.g., UL) DCI for indicating that whether there is a type3 codebook or whether a type3 codebook is triggered. In general, if a codebook (e.g., a type3 codebook, an enhanced type3 codebook, or a retransmitted codebook) is triggered, the user device 102 may determine to transmit, and/or transmit, the codebook. Additionally, if a codebook (e.g., a type3 codebook, an enhanced type3 codebook, or a retransmitted codebook) is not triggered, the user device 102 may determine not to transmit, and/or not transmit, the codebook. For example, the first field may include 1 bit. The value ‘1’ may imply or indicate that there is a type3 codebook or that a type3 codebook is triggered. In addition, the value ‘0’ may indicate or imply that there is no type3 codebook or that no type3 codebook is triggered. If the first field indicates that there is type3 codebook, the type3 codebook may be generated in accordance with the embodiments as described herein. Additionally, the user device 102 may multiplex the HARQ-acknowledgement (ACK) information bits of the type3 codebook in the PUSCH. If the first field indicates that there is no type3 codebook, then the user device 102 may not generate the type3 codebook.

Additionally, in some embodiments, the user device 102 may transmit a PUSCH in a slot to the wireless access node 104. The PUSCH may be scheduled by a second type of (e.g., UL) DCI. The first field in the second type of DCI may indicate that a type3 codebook is triggered. From the perspective of the user device 102, the user device 102 may receive the second type of DCI. Since the first field in the second type of DCI indicates that a type3 codebook is triggered, then the user device 102 may select the PUSCH as a candidate PUSCH for UCI (e.g., HARQ information) multiplexing.

Also, in some embodiments, the user device 102 may transmit a plurality of PUSCHs in a slot to the wireless access node 104. The plurality of PUSCHs may be scheduled by a plurality of second type of (e.g., UL) DCIs transmitted by the wireless access node 104. In some situations, one or more of the plurality of second type of DCIs may indicate that there is type3 codebook in accordance with the above embodiments. In addition or alternatively, one or more of the plurality of second type of DCIs may indicate there is no type3 codebook in accordance with the above embodiments. In other situations, all of the plurality of second type of DCIs may indicate that there is a type3 codebook in accordance with the above embodiments.

Also, in some embodiments, the wireless access node 104 may transmit a plurality of first type of (e.g., DL) DCIs to the user device 102. Each first type of DCI may schedule one or more PDSCH and indicate a PUCCH resource. For at least some of these embodiments, the indicated PUCCH resources are in the same slot with the plurality of PUSCHs. The first field may be included in the first type of (e.g., DL) DCI for indicating whether there is a type3 codebook or whether a type3 codebook is triggered in accordance with the embodiments described herein.

From the perspective of the user device 102, in one case, the user device 102 may not decode and/or detect the first type of DCIs correctly. Correspondingly, the user device 102 may not be aware of the PUCCH resource. For at least some of these situations, the user device 102 may select all PUSCHs scheduled by second type of DCIs that have their first fields indicating there is type3 codebook as candidate PUSCHs for UCI (e.g., HARQ information) multiplexing. More specifically, the user device 102 may select all PUSCHs scheduled by the second type of DCIs having their first fields equal to ‘1’ as the candidate PUSCHs. Additionally, the user device 102 may exclude the PUSCH scheduled by the second type of DCI that have the first field equal to ‘0’ from the candidate PUSCHs for UCI (e.g., HARQ information) multiplexing.

In another case, the user device 102 may decode, detect, and/or receive at least one of the first type of (e.g., DL) DCIs. Correspondingly, the user device 102 may be aware of the PUCCH resource indicated by the decoded first type of DCIs. In some embodiments, all of the decoded first type of DCIs not triggering a type3 codebook may imply that the first field value in the first type of (e.g., DL) DCI does not match (e.g., by not being equal to) the first field value in the second type of (e.g., UL) DCI. In response, the user device 102 may select all of the PUSCHs scheduled by the second type of (e.g., UL) DCI that have the first field indicating there is a type3 codebook as candidate PUSCHs for UCI (e.g., HARQ information) multiplexing. In some embodiments, if the last DCI of the decoded first type of DCIs does not trigger a type3 codebook, the user device 102 may select all the PUSCHs scheduled by the second type of DCI that have the first field indicating there is a type3 codebook as candidate PUSCHs for UCI (e.g., HARQ information) multiplexing.

In another case, the user device 102 may decode, detect, and/or receive) at least one of the first type (e.g., DL) DCIs. Correspondingly, the user device 102 may be aware of the PUCCH resource indicated by the decoded first type of DCIs. In some embodiments, at least one of the decoded first type of DCIs triggering a type3 codebook may imply that the first field value in the first type of (e.g., DL) DCI matches (e.g., by being equal to) the first field value in the second type of (e.g., UL) DCI. In response, the user device 102 may select all PUSCHs that overlap with the PUCCH resource indicated by the first type of DCI that triggers a type3 codebook as the candidate PUSCHs for UCI (e.g., HARQ information) multiplexing. In some embodiments, if a last DCI of the decoded first type of DCIs triggers a type3 codebook, the user device 102 may select all PUSCHs that overlap with the PUCCH resource indicated by the last first type of DCI as the candidate PUSCHs for UCI (e.g., HARQ information) multiplexing.

In some embodiments, the user device 102 may use the first field value in the second type of DCI that indicates there is type3 codebook or a type3 codebook is triggered for determining whether the value of the first field in the first type of DCI and the value of the first field in the second type of DCI match. More specifically, the user device 102 may use the first field value of ‘1’ in the second type of the DCI for determining whether the first field value in the first type of DCI matches the first field value in the second type of DCI.

In some embodiments, the user device 102 may receive a plurality of second type of DCIs. In the event that all the plurality of second type of DCIs indicate that there is no type3 codebook or indicate that no type3 codebook is triggered, the user device 102 may not generate the type3 codebook and not perform HARQ-ACK multiplexing in the PUSCH.

In any case, the user device 102 may select a PUSCH from the candidate PUSCHs for UCI (e.g., HARQ information) multiplexing. For example, from the candidate PUSCHs, the user device 102 may select the PUSCH in the serving cell with the smallest serving cell index for UCI (e.g., HARQ information) multiplexing. If there are more than one PUSCHs in the serving cell with the smallest serving cell index, the user device 102 may further select the earliest PUSCH for UCI (e.g., HARQ information) multiplexing. The user device 102 may transmit at least the specific PUSCH with the multiplexed HARQ information bits.

FIG. 5, illustrates an example of the candidate PUSCH determination for UCI multiplexing in accordance with the embodiments described herein. In the example in FIG. 5, there are two serving cells, denoted by cell 0 and cell 1, respectively. Additionally, PUCCH 1 overlaps with PUSCH 1, PUSCH 2 and PUSCH 4. PUCCH 2 overlaps with both PUSCH 3 and PUSCH 4 in the time domain.

In addition, in the example in FIG. 5, PUCCH 1 and PUCCH 2 are scheduled by first type of DCIs DCI 1_1 and DCI 1_2, respectively. Suppose in the example that the first fields in the DCI 1_1 and 1_2 are ‘0’, and ‘1’, respectively. That is, the DCI 1_2 triggers a type3 codebook and the type3 codebook is carried by PUCCH 2.

Moreover, suppose in the example in FIG. 5 that PUSCH 1, PUSCH 2, PUSCH 3 and PUSCH 4 are scheduled by second type of DCIs DCI 2_1, DCI 2_2, DCI 2_3, and DCI 2_4, respectively. The value of the first field in the DCI 2_1, DCI 2_2, DCI 2_3, and DCI 2_4 are ‘0’, ‘0’, ‘1’, and ‘1’, respectively. That is, DCI 2_3 and DCI 2_4 each indicate that there is a type3 codebook, and DCI 2_1 and DCI 2_2 do not indicate that there is a type3 codebook. Moreover, suppose that the user device 102 detects, decodes, and/or receives DCI 2_1, DCI 2_2, DCI 2_3 and DCI 2_4 correctly. Therefore, the user device 102 may use the first field value ‘1’ to determine whether the first field value in the first type of DCI matches the first field value in the second type of the DCI.

Additionally, in general, when the user device 102 receives information (such as a DCI or information carried by or in a signal or physical channel), the user device 102 may detect or decode the information in order to identify the information (e.g., identify the bit values of the information). As part of the detection or decoding process, the user device 102 may determine whether or not it has successfully identified the information (e.g., that it has determined the bit values without (or with an acceptably low amount of) errors. If the user device 102 determines that it has successfully identified the information, then the user device 102 may determine that it has received, detected, and/or decoded the information correctly. If the user device 102 determines that it has not successfully identified the information, then the user device 102 may determine that it has not received, detected, and/or decoded the information correctly.

In one case, suppose that the user device 102 only detects, decodes, and/or receives DCI 1_1 correctly. Correspondingly, the user device 102 does not decode DCI 1_2 correctly. The user device 102 can be aware of only PUCCH 1. From the perspective of the user device 102, DCI 1_1 is the last DCI of the first type of DCIs. In addition, DCI 1_1 does not trigger a type3 codebook. The first field value (e.g., ‘0’) of the DCI 1_1 is not equal to the first field value (e.g., ‘1’) of DCI 2_3, or DCI 2_4. This implies that the first field value of DCI 1_1 does not match the first field value of DCI 2_3 or DCI 2_4. Therefore, the user device 102 selects PUSCH 3 and PUSCH 4 as candidate PUSCHs, which are scheduled by second type of (e.g. UL) DCI having their first fields indicating there is a type3 codebook.

In another case, suppose that the user device 102 receives both DCI 1_1 and DCI 1_2. Correspondingly, the user device 102 can be aware of the PUCCH 2. From the perspective of the user device 102, DCI 1_2 is the last DCI of the first type of DCIs. In addition, DCI 1_2 triggers a type3 codebook. The first field value (e.g., ‘1’) of the DCI 1_2 is equal to the first field value (e.g., ‘1’) of DCI 2_3, or DCI 2_4. This implies that the first field value of DCI 1_2 matches the first field value of DCI 2_3 or DCI 2_4. Thus, the user device 102 selects the PUSCHs overlapping with PUCCH 2 as the candidate PUSCHs, i.e., PUSCH 3 and PUSCH 4.

In another case, suppose that the user device 102 does not decode both DCI 1_1 and 1_2 correctly. Correspondingly, the user device 102 cannot be aware of both PUCCH 1 and PUCCH 2. In addition, DCI 2_3 and DCI 2_4 each indicate that there is a type3 codebook. Therefore, the user device 102 selects PUSCH 3 and PUSCH 4 as candidate PUSCHs.

In addition, among these candidate PUSCHs, the user device 102 may select PUSCH 4 for UCI multiplexing since cell 0 has the smallest cell index. The user device 102 may generate the type3 codebook in accordance with the embodiments described herein. Then, the user device 102 may multiplex the HARQ information bits of the HARQ codebook in PUSCH 4. The user device 102 may transmit at least PUSCH 4 with multiplexed HARQ information bits.

Additionally, in some embodiments, the wireless access node 104 may configure a plurality of serving cells for a user device 102. For at least some of these embodiments, there may be a plurality of HARQ processes in a serving cell. The wireless access node 104 may configure a plurality of second HARQ codebooks for a user device 102. For each of the second HARQ codebooks, the wireless access node 104 may configure one or more HARQ process in one or more serving cells of the plurality of serving cells. A specific HARQ process in a specific serving cells may be configured for more than one second HARQ codebooks.

Additionally, the user device 102 may construct or generate a second HARQ codebook, such as by concatenating the HARQ information bits, for the configured HARQ process in the configured serving cells. In some embodiments, the second HARQ codebook may be referred to as an enhanced type3 codebook.

For example, two serving cells may be configured for the user device 102, denoted by cell 0 and cell 1. Each cell has a certain number (e.g., eight) HARQ processes. The wireless access node 104 may configure a certain number of (e.g., three) enhanced type3 codebooks for a user device 102, denoted by codebook 0, codebook 1, and codebook 2, respectively. In addition, the wireless access node 104 may configure HARQ process 1, 2, 3, and 4 of cell 0 and HARQ process 2, 3, and 7 of cell 1 for codebook 0. Then, the codebook 0 includes the HARQ information for the HARQ process 1, 2, 3, and 4 of cell 0 and HARQ process 2, 3, and 7 of cell 1. The wireless access node 104 may configure HARQ process 5, 7, 8, and 9 of cell 0 and HARQ process 2, 3, 5, 6, 7, 8 and 9 of cell 1 for codebook 2. Then, the codebook 1 includes the HARQ information for the HARQ process 5, 7, 8, and 9 of cell 0 and HARQ process 2, 3, 5, 6, 7, 8 and 9 of cell 1. The wireless access node 104 may configure HARQ process 2, 4, 6, and 8 of cell 0 for codebook 2. Then, the codebook 2 includes the HARQ information for the HARQ process 2, 4, 6, and 8 of cell 0.

In some embodiments, a second type of (e.g., UL) DCI may schedule one or more PUSCHs. The DCI may include at least one of a second field and a third field. The second field may indicate whether an enhanced type3 codebook is triggered or whether there is an enhanced type3 codebook. For example, the second field may include 1 bit. The value ‘1’ may imply or indicate that there is an enhanced type3 codebook or that an enhanced type3 codebook is triggered. In addition, the value ‘0’ may indicate or imply that there is no enhanced type3 codebook or that no enhanced type3 codebook is triggered. In the event that the second field indicates that there is an enhanced type3 codebook or that an enhanced type3 codebook is triggered, the third field may further indicate which enhanced type3 codebook is triggered among a plurality of enhanced type3 codebooks. The length of the third field may depend on the number of the configured enhanced type3 codebooks. For example, the length of the third field is [log₂ N], where N is the number of the configured enhanced type3 codebooks. Assuming that the network configures three enhanced type3 codebooks, the value ‘00’ may indicate that the first enhanced type3 codebook is triggered. The value ‘01’ may indicate that the second enhanced type3 codebook is triggered. The value ‘10’ may indicate that the third enhanced type3 codebook is triggered. In some embodiments, the second type of (e.g., UL) DCI may only include second field for indicating whether an enhanced type3 codebook is triggered or whether there is an enhanced type3 codebook.

Further, if the second field and the third field indicate that there is an enhanced type3 codebook, the enhanced type3 codebook may be generated in accordance with the embodiments described herein. In addition, the user device 102 may multiplex the HARQ-ACK information bits of the enhanced type3 codebook in the PUSCH. If the second field and/or the third field indicates that there is no enhanced type3 codebook, then the user device 102 may not generate the enhanced type3 codebook.

In some embodiments, the user device 102 may transmit a PUSCH in a slot to the wireless access node 104. The PUSCH may be scheduled by the second type of (e.g., UL) DCI. The second field and the third field in the second type of DCI may indicate that an enhanced type3 codebook is triggered. From the perspective of the user device 102, the user device 102 may receive the second type of (e.g., UL) DCI. Since the second field and the third field in the second type of DCI indicate that an enhanced type3 codebook is triggered, the user device 102 may select the PUSCH as the candidate PUSCH for UCI (e.g., HARQ information) multiplexing.

Additionally, in some embodiments, user device 102 may transmit a plurality of PUSCHs in a slot to the wireless access node 104. The plurality of PUSCHs may be scheduled by a plurality of second type of (e.g., UL) DCIs transmitted by the wireless access node 104. In some situations, one or more of the plurality of second type of DCIs may indicate there is an enhanced type3 codebook in accordance with the above embodiments. In addition or alternatively, one or more of the plurality of second type of (e.g., UL) DCIs may indicate there is no enhanced type3 codebook in accordance with the above embodiments. In other situations, all of the plurality of second type of DCIs may indicate there is an enhanced type3 codebook in accordance with the above embodiments.

Also, in some embodiments, the wireless access node 104 may transmit a plurality of first type of (e.g., DL) DCIs to the user device 102. Each first type of DCI may schedule one or more PDSCH and indicate a PUCCH resource. In some of these embodiments, the indicated PUCCH resources are in the same slot with the plurality of PUSCHs. The second field and the third field in the first type of (e.g., DL) DCI for indicating whether there is an enhanced type3 codebook or whether an enhanced type3 codebook is triggered.

From the perspective of the user device 102, in one case, the user device 102 may not decode and/or detect the first type of (e.g., DL) DCIs correctly. Correspondingly, the user device 102 may not be aware of the PUCCH resource. In turn, the user device 102 may select all of the PUSCHs scheduled by the second type of (e.g., UL) DCI having the second field or third field indicating that there is an enhanced type3 codebook as candidate PUSCHs for UCI (e.g., HARQ information) multiplexing. More specifically, the UE may select all the PUSCHs scheduled by the second type of DCI with the second field equal to ‘1’ as the candidate PUSCHs.

In another case, the user device 102 may decode, detect, and/or receive at least one of the first type of (e.g., DL) DCIs. Correspondingly, the user device 102 may be aware of the PUCCH resource indicated by the decoded first type of DCIs. In some embodiments, all of the decoded first type of DCIs not triggering an enhanced type3 codebook (e.g., the second field value in the first type of DCIs is ‘0’) may imply that the second field value in the first type of (e.g., DL) DCI does not match (e.g., by not being equal to) the second field value in the second type of (e.g., UL) DCI. Then the user device 102 may select all of the PUSCHs scheduled by the second type of DCI that have the second field or third field indicating there is an enhanced type3 codebook as candidate PUSCHs for UCI (e.g., HARQ information) multiplexing. In some embodiments, if the last DCI of the decoded first type of DCIs do not trigger an enhanced type3 codebook (e.g., the second field value is ‘0’), the user device 102 may select all of the PUSCHs scheduled by the second type of DCI having the second field or third field indicating there is an enhanced type3 codebook as candidate PUSCHs for UCI (e.g., HARQ information) multiplexing.

In another case, the user device 102 may decode, detect, and/or receive at least one of the first type of (e.g., DL) DCIs. Correspondingly, the user device 102 may be aware of the PUCCH resource indicated by the decoded first type of DCIs. In some embodiments, at least one of the decoded first type of DCIs triggering an enhanced type3 codebook may imply that the second field value in the first type of (e.g., DL) DCI matches (e.g., by being equal to) the second field value in the second type of (e.g., UL) DCI. The triggered enhanced type3 codebook indicated by the first type of (e.g., DL) DCI being the same as that indicated by the second type of (e.g., UL) DCI may imply that the third field value in the first type of (e.g., DL) DCI matches (e.g., by being equal to) the third field value in the second type of (e.g., UL) DCI. If both the second field and the third field value in the first type of (e.g., DL) DCI match (e.g., by being equal to) the second field and the third field value in the second type of (e.g., UL) DCI, the user device 102 may select all the PUSCHs that overlap with the PUCCH resource indicated by the first type of DCI that triggers an enhanced type3 codebook as the candidate PUSCHs for UCI (e.g., HARQ information) multiplexing. In some embodiments, if the last DCI of the decoded first type of DCIs triggers an enhanced type3 codebook, the user device 102 may select all of the PUSCHs that overlap with the PUCCH resource indicated by the last first type of DCI as the candidate PUSCHs for UCI (e.g., HARQ information) multiplexing.

In any case, the user device 102 may select the specific PUSCH in accordance with the embodiments as described herein. The user device 102 may multiplex the HARQ information bits in the specific PUSCH. The user device 102 may transmit at least the specific PUSCH with the multiplexed HARQ information bits.

In some embodiments, the user device 102 may use the second field value and the third field value in the second type of (e.g., UL) DCI that indicates there is an enhanced type3 codebook or enhanced type3 codebook is triggered for determining whether the second and the third field value in the first type of (e.g., DL) DCI match the second and the third field value in the second type of (e.g., UL) DCI.

In some embodiments, the user device 102 may receive a plurality of second type of (e.g., UL) DCI. In the event that all the plurality of second type of DCIs indicate that there is no enhanced type3 codebook or indicate that no enhanced type3 codebook is triggered, the user device 102 may not generate the enhanced type3 codebook and not perform HARQ-ACK multiplexing in the PUSCH.

Additionally, in some embodiments, a second type of (e.g., UL) DCI may schedule one or more PUSCH. The second type of (e.g., UL) DCI may include a fourth field. The fourth field may indicate whether a HARQ codebook retransmission is triggered or whether there is a HARQ codebook retransmission. For example, the fourth field may include one bit. The value of ‘1’ may indicate that a HARQ codebook retransmission is triggered or there is a HARQ codebook retransmission. The value ‘0’ may indicate that a HARQ codebook retransmission is not triggered or there is no HARQ codebook retransmission. If the fourth field indicates a HARQ codebook retransmission, the user device 102 may multiplex the HARQ information bits of the retransmitted HARQ codebook in the PUSCH scheduled by the second type of (e.g., UL) DCI.

Also, in some embodiments, the user device 102 may transmit a PUSCH in a slot to the wireless access node 104. The PUSCH may be scheduled by a second type of (e.g., UL) DCI. Suppose, for example, that the fourth field in the second type of DCI indicates that there is a HARQ codebook retransmission. From the perspective of the user device 102, the user device 102 may receive the second type of (e.g., UL) DCI. Since the fourth field in the second type of DCI indicates that there is a HARQ codebook retransmission, the user device 102 may select the PUSCH as the candidate PUSCH for UCI (e.g., HARQ information) multiplexing.

In some embodiments, the second type of (e.g., UL) DCI may indicate that multiple (more than one) codebooks are triggered or there are multiple (more than one) codebooks. The user device 102 may generate the multiple codebooks. In addition, the user device 102 may concatenate the HARQ information bits of the generated codebooks. Then, the user device 102 may multiplex the HARQ information bits in the PUSCH. For example, the second DAI in a second type of (e.g., UL) DCI is not equal to 4. The fourth field in the second type of (e.g., UL) DCI may indicate there is a retransmitted codebook. Then the user device 102 may generate a codebook according to the second DAI value and generate the retransmitted codebook. The user device 102 may concatenate the HARQ information bits of the generated codebook and the retransmitted codebook.

Additionally, in some embodiments, the user device 102 may transmit a plurality of PUSCHs in a slot to the wireless access node 104. The plurality of PUSCHs may be scheduled by a plurality of second type of (e.g., UL) DCIs transmitted by the wireless access node 104. In some situations, one or more of the plurality of second type of DCIs may indicate there is a HARQ codebook retransmission in accordance with the above embodiments. In addition or alternatively, one or more of the plurality of second type of DCIs may indicate there is no a HARQ codebook retransmission in accordance with the above embodiments. On other embodiments, all of the plurality of second type of DCIs may indicate there is a HARQ codebook retransmission in accordance with the above embodiments.

The wireless access node 104 may transmit a plurality of first type of (e.g., DL) DCIs to the user device 102. Each first type of DCI may schedule one or more PDSCH and indicate a PUCCH resource. For some of these embodiments, the indicated PUCCH resources are in the same slot with the plurality of PUSCHs. The first type of (e.g., DL) DCI may include the fourth field for indicating whether a HARQ codebook retransmission is triggered or whether there is a HARQ codebook retransmission in accordance with the embodiments described herein.

From the perspective of the user device 102, in one case, the user device 102 may not decode and/or detect the first type of DCIs correctly. Correspondingly, the user device 102 may not be aware of the PUCCH resource. In turn, the user device 102 may select all the PUSCHs scheduled by the second type of DCI with a fourth field indicating there is a HARQ codebook retransmission as candidate PUSCHs for UCI (e.g., HARQ information) multiplexing. More specifically, the user device 102 may select all the PUSCHs scheduled by the second type of DCI with the fourth field equal to ‘1’ as the candidate PUSCHs. Also, the user device 102 may exclude all the PUSCH scheduled by the DCIs having the fourth field equal to ‘0’ from being a candidate PUSCHs for UCI (e.g., HARQ information) multiplexing.

In another case, the user device 102 may decode, detect, and/or receive at least one of the first type of (e.g., DL) DCIs. Correspondingly, the user device 102 may be aware of the PUCCH resource indicated by the decoded first type of DCIs. In some embodiments, all of the decoded first type of DCIs having the fourth field with value ‘0’ may imply that all of the decoded first type of DCIs do not trigger a HARQ codebook retransmission. The fourth field value in the first type of (e.g., DL) DCI does not match (e.g., by not being equal to) the fourth field value in the second type of (e.g., UL) DCI. Then, the user device 102 may select all the PUSCHs scheduled by the second type of DCIs with the fourth field indicating there is a HARQ codebook retransmission as candidate PUSCHs for UCI (e.g., HARQ information) multiplexing. In some embodiments, if the last DCI of the decoded first type of DCIs does not trigger a HARQ codebook retransmission (e.g., the fourth field value is ‘0’), the user device 102 may select all the PUSCHs scheduled by the second type of DCI with the fourth field indicating there is a HARQ codebook retransmission as candidate PUSCHs for UCI (e.g., HARQ information) multiplexing.

In another case, the user device 102 may decode, detect, and/or receive at least one of the first type of (e.g., DL) DCIs. Correspondingly, the user device 102 may be aware of the PUCCH resource indicated by the decoded first type of DCIs. In some embodiments, at least one of the decoded first type of DCIs having the fourth field value of ‘1’ may imply that the at least one of the decoded first type of DCIs triggers a HARQ codebook retransmission. The fourth field value in the first type of (e.g., DL) DCI matches (e.g., by being equal to) the fourth field value in the second type of (e.g., UL) DCI. Then, the user device 102 may select all the PUSCHs that overlap with the PUCCH resource indicated by the first type of DCI that triggers a HARQ codebook retransmission as the candidate PUSCHs for UCI (e.g., HARQ information) multiplexing. In some embodiments, if the last DCI of the decoded first type of DCIs triggers a HARQ codebook retransmission (e.g., the fourth field value is ‘1’), the user device 102 may select all the PUSCHs that overlap with the PUCCH resource indicated by the last first type of DCI as the candidate PUSCHs for UCI (e.g., HARQ information) multiplexing.

In some embodiments, the user device 102 may use the fourth field value (e.g., ‘1’) in the second type of (e.g., UL) DCI that indicates there is an enhanced type3 codebook or enhanced type3 codebook is triggered for determining whether the fourth field value in the first type of (e.g., DL) DCI matches the fourth field value in the second type of (e.g., UL) DCI.

In any case, the user device 102 may select the specific PUSCH in accordance with the embodiments as described herein. The user device 102 may multiplex the HARQ information bits in the specific PUSCH. The user device 102 may transmit at least the specific PUSCH with the multiplexed HARQ information bits.

Additionally, in some embodiments, the wireless access node 104 may transmit a plurality of second type of (e.g., UL) DCIs to the user device 102. A second type of (e.g., UL) DCI may schedule a plurality of PUSCHs. The plurality of PUSCHs may be transmitted on more than one slots or sub-slots. The plurality of scheduled PUSCHs may be indicated by the time domain resource allocation (TDRA) field in the second type of (e.g., UL) DCI.

In some embodiments, the second type of (e.g., UL) DCI may indicate that there is a codebook in accordance with the embodiments described herein. For example, the second DAI value in the second type of (e.g., UL) DCI is not equal to 4. Alternatively, the first field, the second field, the third field, or the fourth field in the second type of (e.g., UL) DCI indicates that there is codebook (e.g., a type3 codebook, an enhanced type3 codebook, or retransmitted codebook). In the event that the user device 102 is not aware of the PUCCH resource for carrying the HARQ-ACK codebook, the user device 102 may multiplex the HARQ-ACK information bits of the codebook in a specific PUSCH of the plurality of PUSCHs or the user device 102 may determine a specific PUSCH of the plurality of PUSCHs as the candidate PUSCH for UCI (e.g., HARQ information) multiplexing.

In some embodiments, the wireless node 104 may indicate the specific PUSCH. For at least some of these embodiments, the second type of (e.g., UL) DCI may include a fifth field for indicating the specific PUSCH. The fifth field may include [log₂ M] bits, where M is the number of the plurality of PUSCHs. Alternatively, M may be the maximum number of the plurality of PUSCHs that the wireless node 104 can schedule. In some examples, M is 4, and the fifth field includes a two-bit value to indicate a specific PUSCH. For example, the fifth field with value ‘00’ may indicate that the specific PUSCH is the first PUSCH, the fifth field with value ‘01’ may indicate that the specific PUSCH is the second PUSCH, and so on.

In some embodiments, one of the plurality of PUSCHs may be specified as the specific PUSCH by a protocol according to which the user device 102 and the wireless access node 104 communicate. For example, the specific PUSCH may be the first PUSCH or the last PUSCH of the plurality of the PUSCHs as specified by the protocol.

As an example illustration, a second type of (e.g., UL) DCI may schedule four PUSCHs, denoted by PUSCH 0, PUSCH 1, PUSCH 2, PUSCH 3, respectively. Suppose that the user device 102 does not detect (or receive) any of the first type of (e.g., DL) DCI correctly. Therefore, the user device 102 does not know the PUCCH resource carrying HARQ information. If the fifth field in the second type of (e.g., UL) DCI is ‘00’, the user device 102 may determine PUSCH 0 as the candidate PUSCHs for UCI (e.g., HARQ information) multiplexing, or the user device 102 may multiplex the HARQ information in the PUSCH 0. If the fifth field in the second type of (e.g., UL) DCI is ‘01’, the user device 102 may determine PUSCH 1 as the candidate PUSCHs for UCI (e.g., HARQ information) multiplexing or the user device 102 may multiplex the HARQ information in the PUSCH 1. If the fifth field in the second type of (e.g., UL) DCI is ‘10’, the user device 102 may determine PUSCH 2 as the candidate PUSCHs for UCI (e.g., HARQ information) multiplexing, or the user device 102 may multiplex the HARQ information in the PUSCH 2. If the fifth field in the second type of (e.g., UL) DCI is ‘11’, the user device 102 may determine PUSCH 3 as the candidate PUSCHs for UCI (e.g., HARQ information) multiplexing or the user device 102 may multiplex the HARQ information in the PUSCH 3.

Alternatively, if the first PUSCH is specified, then the user device 102 may determine PUSCH 0 as the candidate PUSCHs for UCI (e.g., HARQ information) multiplexing or the user device 102 may multiplex the HARQ information in the PUSCH 0. If the last PUSCH is specified, the user device 102 may determine PUSCH 3 as the candidate PUSCHs for UCI (e.g., HARQ information) multiplexing or the user device 102 may multiplex the HARQ information in the PUSCH 3.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: determining, by a user device, whether a first value indicated by a first type of downlink control information (DCI) matches a second value indicated by a second type of DCI; and selecting, by the user device, a candidate physical uplink shared channel (PUSCH) for uplink control information (UCI) multiplexing based on at least determining whether the first value matches the second value.

A second aspect includes the first aspect, and further includes wherein the first value comprises a first downlink assignment index (DAI) value indicated by a DAI field in the first type of DCI and the second value comprises a second DAI value indicated by a DAI field in the second type of DCI.

A third aspect includes the second aspect, and further includes wherein selecting the candidate PUSCH for UCI multiplexing based on at least whether the first DAI value matches the second DAI value comprises: in response to determining that the first DAI value matches the second DAI value, and at least one of: there is at least one physical uplink control channel (PUCCH) resource carrying a hybrid automatic repeat request (HARQ) information, or the first DAI value or the second DAI value is not equal to 4, selecting a PUSCH that overlaps with a PUCCH resource of the at least one PUCCH resource that is indicated by the first type of DCI as the candidate PUSCH for UCI multiplexing.

A fourth aspect includes any of the second or third aspects, and further includes wherein selecting the candidate PUSCH for UCI multiplexing based on at least whether the first DAI value matches the second DAI value comprises: in response to determining that the first DAI value does not match the second DAI value or determining that there are no physical uplink control channel (PUCCH) resources carrying a hybrid automatic repeat request (HARQ) information, selecting a PUSCH scheduled by the second type of DCI as the candidate PUSCH for UCI multiplexing if the second DAI value indicated by the second type of DCI does not equal four.

A fifth aspect includes any of the first through fourth aspects, and further includes wherein the first type of DCI comprises a last first type of DCI that the user device detects or the first type of DCI with the largest DAI value that the user device detects.

A sixth aspect includes any of the second through fifth aspects, and further includes wherein the first DAI value comprises one of a plurality of first DAI values indicated by a plurality of first type of DCIs, wherein the second DAI value comprises one of a plurality of second DAI values indicated by a plurality of second type of DCIs, and, in response to the plurality of second DAI values being the same, selecting the second DAI value indicated by any of the plurality of second type of DCIs to determine whether the first DAI value matches the second DAI value; and in response to the plurality of second DAI values being different, selecting the second DAI value indicated by any of the plurality of second type of DCIs or selecting the largest second DAI value to determine whether the first DAI value matches the second DAI value if none of the plurality of second DAI values is equal to four.

A seventh aspect includes the first aspect, and further includes wherein the first value comprises a value of a first field in the first type of DCI, wherein the first field indicates whether to trigger a type3 codebook, or a retransmitted codebook, and the second value comprises a value of a second field in the second type of DCI, wherein the second field indicates whether to trigger a type3 codebook, or a retransmitted codebook.

An eighth aspect includes the first aspect, and further includes wherein the first value comprises a value of a first field in the first type of DCI and a value of a second field in the first type of DCI, wherein the first field indicates whether to trigger an enhanced type3 codebook and the second field indicates one of the enhanced type3 codebook among a plurality of enhanced type3 codebooks, and the second value comprise a value of a third field in the second type of DCI and a value of a fourth field in the second type of DCI, wherein the third field indicates whether to trigger an enhanced type3 codebook and the fourth field indicates one of the enhanced type3 codebooks among a plurality of enhanced type3 codebooks.

A ninth aspect includes the eighth aspect, and further includes determining the first value matches the second value in response to determining that the value of the first field matches the value of the third field and the value of the second field matches the value of the fourth field, and determining the first value does not match the second value in response to determining that the value of the first field does not match the value of the third field or determining that the value of the second field does not match the value of the fourth field.

A tenth aspect includes the any of the eighth or ninth aspects, and further includes wherein selecting the candidate PUSCH for UCI multiplexing based on determining whether the first type of DCI triggers a type3 codebook, an enhanced type3 codebook, or a retransmitted codebook comprises: in response to determining that the first value matches the second value, and at least one of: there is at least one PUCCH resource carrying a HARQ information, or the second type of DCI indicates that there is a type3 codebook, an enhanced type3 codebook, or a retransmitted codebook, selecting, by the user device, a PUSCH that overlaps with physical uplink control channel (PUCCH) resources indicated by the first type of DCI as the candidate PUSCH for UCI multiplexing.

An eleventh aspect includes any of the eighth or ninth aspects, and further includes wherein selecting the candidate PUSCH for UCI multiplexing based on determining whether the first type of DCI triggers a type3 codebook, an enhanced type3 codebook, or a retransmitted codebook comprises: in response to determining that at least one of: the first value does not match the second value, the first type of DCI does not trigger a type3 codebook, an enhanced type3 codebook, or a retransmitted codebook, there are no PUCCH resources carrying hybrid automatic repeat request (HARQ) information, or the second type of DCI indicates that there is a type3 codebook, an enhanced type3 codebook, or a retransmitted codebook, selecting, by the user device, a PUSCH scheduled by a second type of DCI that indicates that there is a type3 codebook, an enhanced type3 codebook, or a retransmitted codebook as the candidate PUSCH.

A twelfth aspect includes any of the eighth or ninth aspects, and further includes wherein the first value comprises one of a plurality of first values indicated by a plurality of first type of DCIs, wherein the second value comprises one of a plurality of second values indicated by a plurality of second type of DCIs, and, in response to the plurality of second values being the same, selecting the second value indicated by any of the plurality of second type of DCIs to determine whether the first value matches the second value; and in response to the plurality of second values being different, selecting the second value indicated by any of the plurality of second type of DCIs to determine whether the first value matches the second value if the plurality of second type of DCIs indicates that there is a type3 codebook, an enhanced type3 codebook, or a retransmitted codebook.

A thirteenth aspect includes a method for wireless communication that includes: transmitting, by a wireless access node, a first type of downlink control information (DCI) indicating a first value and a second type of DCI indicating a second value; and receiving, by the wireless access node, a physical uplink shared channel (PUSCH) with a multiplexed uplink control information (UCI) corresponding to at least whether the first value and the second value match.

A fourteenth aspect includes the thirteenth aspect, and further includes wherein the first value comprises a first downlink assignment index (DAI) value indicated by a DAI field in the first type of DCI and the second value comprises a second DAI value indicated by a DAI field in the second type of DCI.

A fifteenth aspect includes the fourteenth aspect, and further includes wherein when the first DAI value matches the second DAI value and at least one of: there is at least one physical uplink control channel (PUCCH) resource carrying hybrid automatic repeat request (HARQ) information, or the first DAI value or the second DAI value is not equal to 4, the PUSCH overlaps and/or the PUSCH that the wireless access node receives is dependent on the PUSCH overlapping, with a PUCCH resource indicated by the first type of DCI.

A sixteenth aspect includes any of the fourteenth or fifteenth aspects, and further includes wherein when the first DAI value does not match the second DAI value, or there are no physical uplink control channel (PUCCH) resources carrying a hybrid automatic repeat request (HARQ) information, the PUSCH is scheduled, and/or the PUSCH that the wireless access node receives is dependent on the PUSCH being scheduled, by the second type of DCI if the second DAI value indicated by the second type of DCI does not equal 4.

A seventeenth aspect includes any of the thirteenth through sixteenth aspects, and further includes wherein the first type of DCI comprises a last first type of DCI that the wireless access node transmits or the first type of DCI from among a plurality of first type of DCIs with the largest DAI value that the wireless access node transmits.

An eighteenth aspect includes the thirteenth aspect, and further includes wherein the first value comprises a value of a first field in the first type of DCI, wherein the first field indicates whether to trigger a type3 codebook, or a retransmitted codebook, and the second value comprises a value of a second field in the second type of DCI, wherein the second field indicates whether to trigger a type3 codebook, or a retransmitted codebook.

A nineteenth aspect includes the thirteenth aspect, and further includes wherein the first value comprises a value of a first field in the first type of DCI and a value of a second field in the first type of DCI, wherein the first field indicates whether to trigger an enhanced type3 codebook and the second field indicates one of the enhanced type3 codebook among a plurality of enhanced type3 codebooks, and the second value comprise a value of a third field in the second type of DCI and a value of a fourth field in the second type of DCI, wherein the third field indicates whether to trigger an enhanced type3 codebook and the fourth field indicates one of the enhanced type3 codebooks among a plurality of enhanced type3 codebooks.

A twentieth aspect includes the nineteenth aspect, and further includes wherein: the first value matches the second value when the value of the first field matches the value of the third field and the value of the second field matches the value of the fourth field, and the first value does not match the second value when the value of the first field does not match the value of the third field or the value of the second field does not match the value of the fourth field.

A twenty-first aspect includes any of the nineteenth or twentieth aspects, and further includes wherein the PUSCH comprises a PUSCH that overlaps with a physical uplink control channel (PUCCH) resource indicated by the first type of DCI in response to the first value matching the second value and at least one: there is at least one PUCCH resource carrying a HARQ information, or the second type of DCI indicates that there is a type3 codebook, an enhanced type3 codebook, or a retransmitted codebook.

A twenty-second aspect includes any of the nineteenth or twentieth aspects, and further includes wherein the PUSCH comprises a PUSCH scheduled by the second type of DCI that indicates that there is a type3 codebook, an enhanced type3 codebook, or a retransmitted codebook as the candidate PUSCH in response to at least one of: the first value does not match the second value, the first type of DCI does not trigger a type3 codebook, an enhanced type3 codebook, or a retransmitted codebook, there are no PUCCH resources carrying hybrid automatic repeat request (HARQ) information, or the second type of DCI indicates that there is a type3 codebook, an enhanced type3 codebook, or a retransmitted codebook.

A twenty-third aspect includes any of the first through twenty-second aspects, and further includes wherein the first type of DCI comprises a downlink (DL) DCI, and wherein the second type of DCI comprises an uplink (UL) DCI.

A twenty-fourth aspect includes a wireless communications apparatus comprising a processor and a memory, wherein the processor is configured to read code from the memory to implement any of the first through twenty-third aspects.

A twenty-fifth aspect includes a computer program product comprising a computer-readable program medium comprising code stored thereupon, the code, when executed by a processor, causing the processor to implement any of the first through twenty-third aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, by a user device, whether a first value indicated by a first type of downlink control information (DCI) matches a second value indicated by a second type of DCI; and
selecting, by the user device, a candidate physical uplink shared channel (PUSCH) for uplink control information (UCI) multiplexing based on at least determining whether the first value matches the second value.

2. The method of claim 1, wherein the first value comprises a first downlink assignment index (DAI) value indicated by a DAI field in the first type of DCI and the second value comprises a second DAI value indicated by a DAI field in the second type of DCI.

3. The method of claim 2, wherein selecting the candidate PUSCH for UCI multiplexing based on at least whether the first DAI value matches the second DAI value comprises:
in response to determining that the first DAI value matches the second DAI value, and at least one of: there is at least one physical uplink control channel (PUCCH) resource carrying a hybrid automatic repeat request (HARQ) information, or the first DAI value or the second DAI value is not equal to 4, selecting a PUSCH that overlaps with a PUCCH resource of the at least one PUCCH resource that is indicated by the first type of DCI as the candidate PUSCH for UCI multiplexing.

4. The method of claim 2, wherein selecting the candidate PUSCH for UCI multiplexing based on at least whether the first DAI value matches the second DAI value comprises:
in response to determining that the first DAI value does not match the second DAI value or determining that there are no physical uplink control channel (PUCCH) resources carrying a hybrid automatic repeat request (HARQ) information, selecting a PUSCH scheduled by the second type of DCI as the candidate PUSCH for UCI multiplexing if the second DAI value indicated by the second type of DCI does not equal four.

5. The method of claim 1, wherein the first type of DCI comprises a last first type of DCI that the user device detects or the first type of DCI with the largest DAI value that the user device detects.

6. The method of claim 2, wherein the first DAI value comprises one of a plurality of first DAI values indicated by a plurality of first type of DCIs, wherein the second DAI value comprises one of a plurality of second DAI values indicated by a plurality of second type of DCIs, the method further comprising:
in response to the plurality of second DAI values being the same, selecting the second DAI value indicated by any of the plurality of second type of DCIs to determine whether the first DAI value matches the second DAI value; and
in response to the plurality of second DAI values being different, selecting the second DAI value indicated by any of the plurality of second type of DCIs or selecting the largest second DAI value to determine whether the first DAI value matches the second DAI value if none of the plurality of second DAI values is equal to four.

7. The method of claim 1, wherein the first type of DCI comprises a downlink (DL) DCI, and wherein the second type of DCI comprises an uplink (UL) DCI.

8. The method of claim 1, wherein the first value comprises a value of a first field in the first type of DCI, wherein the first field indicates whether to trigger a type3 codebook, or a retransmitted codebook, and
the second value comprises a value of a second field in the second type of DCI, wherein the second field indicates whether to trigger a type3 codebook, or a retransmitted codebook.

9. The method of claim 1, wherein the first value comprises a value of a first field in the first type of DCI and a value of a second field in the first type of DCI, wherein the first field indicates whether to trigger an enhanced type3 codebook and the second field indicates one of the enhanced type3 codebook among a plurality of enhanced type3 codebooks, and
the second value comprise a value of a third field in the second type of DCI and a value of a fourth field in the second type of DCI, wherein the third field indicates whether to trigger an enhanced type3 codebook and the fourth field indicates one of the enhanced type3 codebooks among a plurality of enhanced type3 codebooks.

10. The method of claim 9, further comprises,
determining the first value matches the second value in response to determining that the value of the first field matches the value of the third field and the value of the second field matches the value of the fourth field, and
determining the first value does not match the second value in response to determining that the value of the first field does not match the value of the third field or determining that the value of the second field does not match the value of the fourth field.

11. The method of claim 9, wherein selecting the candidate PUSCH for UCI multiplexing based on determining whether the first type of DCI triggers a type3 codebook, an enhanced type3 codebook, or a retransmitted codebook comprises:
in response to determining that the first value matches the second value, and at least one of: there is at least one PUCCH resource carrying a HARQ information, or the second type of DCI indicates that there is a type3 codebook, an enhanced type3 codebook, or a retransmitted codebook, selecting, by the user device, a PUSCH that overlaps with physical uplink control channel (PUCCH) resources indicated by the first type of DCI as the candidate PUSCH for UCI multiplexing.

12. The method of claim 9, wherein selecting the candidate PUSCH for UCI multiplexing based on determining whether the first type of DCI triggers a type3 codebook, an enhanced type3 codebook, or a retransmitted codebook comprises:
in response to determining that at least one of: the first value does not match the second value, the first type of DCI does not trigger a type3 codebook, an enhanced type3 codebook, or a retransmitted codebook, there are no PUCCH resources carrying hybrid automatic repeat request (HARQ) information, or the second type of DCI indicates that there is a type3 codebook, an enhanced type3 codebook, or a retransmitted codebook, selecting, by the user device, a PUSCH scheduled by a second type of DCI that indicates that there is a type3 codebook, an enhanced type3 codebook, or a retransmitted codebook as the candidate PUSCH.

13. The method of claim 9, wherein the first value comprises one of a plurality of first values indicated by a plurality of first type of DCIs, wherein the second value comprises one of a plurality of second values indicated by a plurality of second type of DCIs, the method further comprising:
in response to the plurality of second values being the same, selecting the second value indicated by any of the plurality of second type of DCIs to determine whether the first value matches the second value; and
in response to the plurality of second values being different, selecting the second value indicated by any of the plurality of second type of DCIs to determine whether the first value matches the second value if the plurality of second type of DCIs indicates that there is a type3 codebook, an enhanced type3 codebook, or a retransmitted codebook.

14. A method for wireless communication, the method comprising:
transmitting, by a wireless access node, a first type of downlink control information (DCI) indicating a first value and a second type of DCI indicating a second value; and
receiving, by the wireless access node, a physical uplink shared channel (PUSCH) with a multiplexed uplink control information (UCI) corresponding to at least whether the first value and the second value match.

15. The method of claim 14, wherein the first value comprises a first downlink assignment index (DAI) value indicated by a DAI field in the first type of DCI and the second value comprises a second DAI value indicated by a DAI field in the second type of DCI.

16. The method of claim 15, wherein when the first DAI value matches the second DAI value and at least one of: there is at least one physical uplink control channel (PUCCH) resource carrying hybrid automatic repeat request (HARQ) information, or the first DAI value or the second DAI value is not equal to 4, the PUSCH overlaps with a PUCCH resource indicated by the first type of DCI.

17. The method of claim 15, wherein when the first DAI value does not match the second DAI value, or there are no physical uplink control channel (PUCCH) resources carrying a hybrid automatic repeat request (HARQ) information, the PUSCH is scheduled by the second type of DCI if the second DAI value indicated by the second type of DCI does not equal 4.

18. The method of claim 14, wherein the first type of DCI comprises a last first type of DCI that the wireless access node transmits or the first type of DCI from among a plurality of first type of DCIs with the largest DAI value that the wireless access node transmits.

19. The method of claim 14, wherein the first type of DCI comprises a downlink (DL) DCI, and wherein the second type of DCI comprises an uplink (UL) DCI.

20. The method of claim 14, wherein the first value comprises a value of a first field in the first type of DCI, wherein the first field indicates whether to trigger a type3 codebook, or a retransmitted codebook, and
the second value comprises a value of a second field in the second type of DCI, wherein the second field indicates whether to trigger a type3 codebook, or a retransmitted codebook.
